(19) United States
(12) Patent Application Publication
(10) Pub. No.: US 2015/0089674 A1
(43) Pub. Date: Mar. 26, 2015

(54) DEVICE LOCK AND AUTOMATIC PUBLICATION IN LOST AND FOUND DATABASE

(71) Applicant: Absolute Software Corporation, Vancouver (CA)

(72) Inventor: Ward Clapham, Surrey (CA)

(21) Appl. No.: 14/035,729

(22) Filed: Sep. 24, 2013

(51) Int. Cl. G06F 21/00

(52) U.S. Cl. CPC G06F 21/00
USPC 726/34

(57) ABSTRACT

Electronic devices are registered with a device lock service during the out of box experience. Following theft or loss of the device, an instruction can be given to remotely lock the device and at the same time publish the device as lost or stolen in a lost and found database.

### TECHNICAL FIELD

The present disclosure relates to the protection of electronic devices from theft, and in particular to systems and methods for facilitating the retrieval of such devices after loss or theft.

### BACKGROUND

Personal electronic computing or communications devices such as laptops, netbooks, cell phones, personal digital assistants, smart phones, memory sticks, personal media devices, gaming devices, tablet computers, electronic books and personal computers are often lost or stolen. Since valuable personal or proprietary information is routinely stored on such devices, the need to protect such proprietary or sensitive data as soon as possible is self-evident.

While screen locks or time-based locks exist on many devices, they are often disabled by the users of such devices for convenience.

Following the proliferation of mobile devices and the quantity of valuable data stored on them, several remote lock services have become available to allow a user to remotely lock a lost or stolen device. In order for this to work, a user must pre-register the device with a server before the loss or theft and then issue a lock command via the internet if the device is later lost or stolen. A lock command may completely lock the device or permit a limited function, such as the display of a number to call in case the device is found.

Many people do not register for such a service because they think they are careful enough not to need it, they procrastinate or they are unaware of the existence of such a service. Since many services can be subscribed to as and when needed, some people may mistakenly think that they can subscribe to a lock service after their device has been lost or stolen.

If a device such as a phone is lost, there is a short window of opportunity to phone it while the battery still has charge, in the hope that someone who may have found it will return it. If the battery is out of charge, then whoever found it may hand it in to the venue where it was found or to the police.

When a smart phone in particular is lost or stolen, owners often purchase a replacement without waiting to see if it can be found, since many people feel they need one to be connected 24/7. Nevertheless, there is still value in retrieving the original because it may contain photos of high sentimental value or it may be useful as a backup device or for another family member.

If a device is lost or stolen, it is a fairly onerous task for the owner to submit details of it to a lost and found database. Firstly, the serial number should be found in order to identify the device. Secondly, one or more lost and found databases must be researched and a decision made as to which one or ones to use. Thirdly, details must be repeatedly submitted if entry in more than one database is desired. Lastly, the relatively low perceived likelihood of the device being found, while possible, may not justify the effort required to submit details of its theft or loss to such databases.

Another problem is that if there are several lost and found databases, whoever ends up in possession of a lost device is not likely to have neither the time nor the inclination to search through them all for a registered owner.

### SUMMARY

Disclosed is a method for protecting electronic devices comprising: receiving by an electronic device, during an out of box experience of the device, user contact data for a purpose other than for registering for a remote lock service; presenting, by the device during the out of box experience, an opportunity to register the device with the remote lock service; receiving, by the device during the out of box experience, an acceptance of said opportunity; the device using said user contact data to register the device with a server which provides the remote lock service; receiving, by said lock service, a notification of loss or theft of the device; and transmitting a lock command to the device.

The method may further comprise the device receiving the lock command and restricting its functionality as a result.

The method may further comprise: presenting, by the device during the out of box experience, an opportunity to pre-register the device with a lost and found service; receiving, by the device during the out of box experience, an acceptance of said opportunity to pre-register the device with the lost and found service; and the device using said user contact data to register the device with the lost and found service.

Acceptance of both the opportunity to register the device with the remote lock service and the opportunity to pre-register the device with the lost and found service may occur simultaneously.

The method may further comprise, after receiving said notification: presenting, by the server, an opportunity to register the device with a lost and found service; receiving, by the server, an acceptance of said opportunity to register the device with the lost and found service; the server using said user contact data to register the device with the lost and found service; and publishing, by the lost and found service, that the device is lost or stolen.

The device may automatically send an identification of itself to the server when registering for the remote lock service.

This summary is not an extensive overview intended to delineate the scope of the subject matter that is described and claimed herein. The summary presents aspects of the subject matter in a simplified form to provide a basic understanding thereof, as a prelude to the detailed description that is presented below. Neither this summary, nor the drawings, nor the following detailed description purport to define or limit the invention; the invention is defined only by the claims.

Further disclosed are on or more computer readable media carrying computer readable instructions, which, when processed by one or more processors, cause a system to carry out the steps described above. Such media may also be configured to carry out further steps as described herein. The computer readable instructions may be persistently stored on a non-transitory computer readable storage medium.

Still further disclosed is a system for protecting electronic devices comprising: an electronic device configured to receive, during an out of box experience of the device, user contact data for a purpose other than for registering for a remote lock service; present, during the out of box experience, an opportunity to register the device with the remote lock service; receive, during the out of box experience, an acceptance of said opportunity; and use said user contact data to register the device with a server which provides the remote lock service; and the server configured to provide the remote lock service; receive a notification of loss or theft of the device; and transmit a lock command to the device.

The electronic device may further be configured to: present, during the out of box experience, an opportunity to pre-register the device with a lost and found service; receive, during the out of box experience, an acceptance of said opportunity to pre-register the device with the lost and found service; and use said user contact data to register the device with the lost and found service; and includes the lost and found service, comprising a database of electronic devices that may be published as lost or stolen. The device is further configured to receive the lock command and restrict the functionality of the device upon receipt of the lock command.

The server of the system may further be configured to: present, after said notification has been received, an opportunity to register the device with a lost and found service; receive an acceptance of said opportunity to register the device with the lost and found service; and use said user contact data to register the device with the lost and found service; and the lost and found service is further configured to publish that the device is lost or stolen.

### BRIEF DESCRIPTION OF THE DRAWINGS

For a fuller understanding of the nature and advantages of the disclosed subject matter, as well as the preferred mode of use thereof, reference should be made to the following detailed description, read in conjunction with the accompanying drawings. In the drawings, like reference numerals designate like or similar steps or parts.

FIG. 1 is a schematic diagram of a system for device lock and automated entry into a lost and found database according to an embodiment of the invention.

FIG. 2 is a schematic diagram of a screen shot that appears during an out of box experience according to an embodiment of the invention.

FIG. 3 is a flowchart of a process carried out by the system during an out of box experience according to an embodiment of the invention.

FIG. 4 is a flowchart of a process carried out by the system following theft or loss of a device according to an embodiment of the invention.

FIG. 5 is a flowchart of a process carried out by the system after a lost or stolen device is found according to an embodiment of the invention.

### DETAILED DESCRIPTION OF SPECIFIC EMBODIMENTS

As used herein, a device is any electronic device or any computing device to be protected. Non-limiting examples of a device include a laptop, cell phone, personal digital assistant, smart phone, memory stick, personal media device, gaming device, personal computer, tablet computer, electronic book, camera with a network interface, and netbook. Most devices protected by the invention will be mobile devices, but static devices, such as desk top computers, projectors, televisions, photocopiers and appliances may also be protected. Many other kinds of electronic devices may be included, such as hi-fi equipment, cameras, bicycles, cars, barbecues and toys. Devices are configured to communicate with a remote server. They may initiate the communications or the communications may be initiated by the server. Communications may be via Wi-Fi, SMS or satellite, for example, or may use another communications protocol. While the invention is often explained in relation to mobile devices, it is to be understood that it applies equally to static devices.

As used herein, an owner is actual owner of a device. Where the term owner is used, a user who is authorized by the owner to use the device or to act on behalf of the owner may equally be substituted.

As used herein, an out-of-box experience (OOBE) refers to the experience an owner has when preparing to first use a new product, such as an electronic device, usually straight after taking it out of its box or other packaging. This typically includes the setup process of installing and/or performing initial configuration of the device, and generally follows the point-of-sale experience. Registration of the device with its manufacturer is often a component of an OOBE, in which an owner provides his name and/or email address to the manufacturer, the device itself providing its identity to the manufacturer.

As used herein, a responsible party refers to, for example, an individual or corporate third party that owns or operates the server described herein, in whole or in part, or is charged with the recovery and return of lost or stolen devices to their rightful owners. It may be preferable for owners of devices to use such a responsible party to avoid making their own contact information available to the general public.

As used herein, a lock command is a remotely initiated instruction sent via a server to the device to cause it to stop operating, either in full or partially. It may mean ‘killing’ the device so that it becomes completely inoperable, in which case the lock command will be a kill switch. Alternately, the lock command may disable everything but the display of a telephone number to call to report that the device has been found, or an email address to contact, or both. The device may still permitted to contact this number or email, without being permitted to contact other emails or numbers, except perhaps an emergency services number.

The detailed descriptions within are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps involve physical manipulations of physical quantities. Often, but not necessarily, these quantities take the form of electrical or magnetic signals capable of being stored, transferred, combined, compared, and otherwise manipulated. It will be further appreciated that the line between hardware, software and firmware is not always sharp, it being understood by those skilled in the art that software implemented processes may be embodied in hardware, firmware, or software, in the form of coded instructions such as in microcode and/or in stored programming instructions. Computer readable memory or media described herein are all non-transitory in that they store computer readable instructions and/or computer readable data either permanently or temporarily. A medium that can only support a propagating signal without storing it is considered to be transitory.

In general, unless otherwise indicated, singular elements may be in the plural and vice versa with no loss of generality. The use of the masculine can refer to masculine, feminine or both. Note that the Drawings of the application are not to scale.

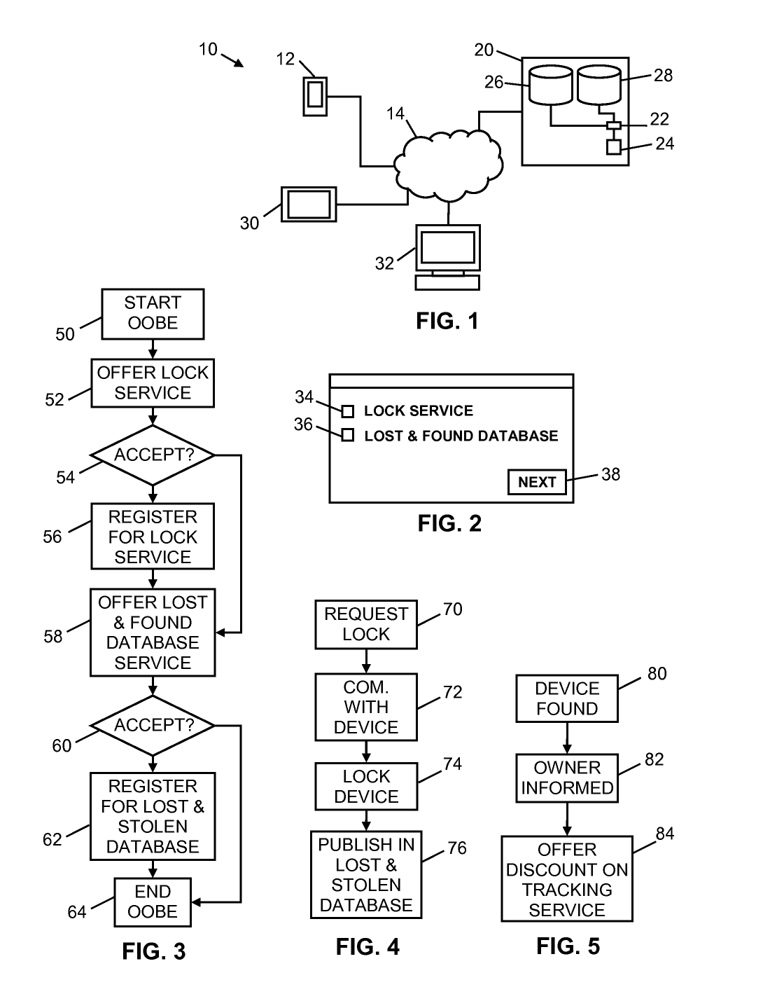

A symbolic block diagram of a preferred embodiment of the overall system 10 for protection of a device is shown in FIG. 1. During the OOBE, an owner's device 12 is connected via a network 14 to a server 20. The network may be the internet, a telecommunications network, or a combination of both. The device 12 may be connected to the network wirelessly or by wired or cable connections; such connections may be intermittent or continuous. This also applies for all other connections shown.

The server 20 includes one or more processors 22 operably connected to computer readable memory 24, which stores computer readable instructions that, when processed by the processor(s), provide at least some of the functionality of the system. The server 20 includes or has access to a lock database 26, which contains identifications of devices that are registered for a remote lock service in the case of their theft or loss. This lock database 26 and the server 20 may be referred to as a remote lock service. The server 20 also includes or has access to a lost and found database 28, which contains details of devices that have been lost or stolen. Server 20 and lost and found database 28 form part of a lost and found service.

Also connected to the system 10 is a further device 30, via which an owner can submit a lock command to the device 12 following its loss or theft. This further device 30 may be another device owned by the owner of device 12, or a device borrowed by the owner.

Yet a further device 32 is connected to the system 10. This device 32 is used by a finder of a device 12 that has been lost or stolen to access the lost and found database 28, in order to see whether the device 12 is registered there and, if so, to retrieve directions as to how to return the device to its owner.

Of course, the lost and found database 28 may also be used by finders of devices to store details of devices that they find, without the devices having been previously registered as lost or stolen in it by their owners. Such details may be added to the lost and found database 28 via, for example, device 12, 30 or 32, or via other suitable devices.

Devices 12, 30, 32 include the necessary processors, computer readable media, computer readable instructions, interfaces and other usual components in order for them to communicate with and carry out at least some of the functions of the system.

Referring to FIG. 2, an example of a screenshot is shown that is displayed during the OOBE for the device 12. The screenshot displays a check box 34, which gives the owner the option to register for a remote device lock service. Presumably the owner will already have entered contact details and a password when registering the device 12 with its manufacturer, and so all that is further needed from the owner is to click on check box 34 or perform such other equivalent action that results in its selection. The owner's contact details and the password will be used by the server 20 for permitting access to the owner when submitting a command to lock the device 12 if it is later lost or stolen. Likewise, the device serial number and/or telephone number of device 12 will automatically be used for registering with the lock service so that the device can be identified when an instruction is received to lock it.

The screenshot also displays another check box 36, which gives the owner option for pre-registering the device 12 with the lost and found database 28. As above, the owner will already have entered contact details and a password when registering the device 12 with its manufacturer. All that is needed is for the owner to click on the check box 36 or perform such other equivalent action that results in its selection. The next button 38 may be clicked when the owner has chosen whether to select the options given by the check boxes 34, 36. In other embodiments, the check boxes 34, 36 and related options may appear in an existing window that appears during the OOBE, or a window with further OOBE options or configuration choices to be made.

In some embodiments, the two check boxes 34, 36 may be combined into one, to further minimize the effort required of the owner.

The inventor has realized that many owners do not think that registering for a lock service and/or pre-registering a device in a lost and found database is worth the effort required by prior art offerings. As a result, the inventor has found a way to massively reduce the effort required of the owner to make it a worthwhile process. In effect, the effort has been reduced to a small number of clicks, and possibly as few as one click. Further, the effort required has been scheduled to be needed during the OOBE, which is typically the one and only moment when the owner is focused on setting up the device 12. Since the owner is already in such a mindset and the effort required is extremely small, the likelihood of procrastination relating to registering for a lock service or pre-registering for a lost and found database is much diminished.

FIG. 3 is a flowchart of an example of a process carried out by the system 10 during an out of box experience for a device 12. In step 50 the OOBE is started, usually but not necessarily by the device 12 being switched on for the first time by the owner after its purchase. Among the various display screens presented to the owner during the OOBE, one of them offers the owner an option to subscribe to a device lock service, in step 52. If, at step 54, the owner accepts the offer to subscribe to the lock service, the system registers the device 12 with all the necessary information at the server 20 in step 56. The necessary information would typically include the owner's contact details, the identification of the device 12, and may also include the type of device, model and way in which it should be communicated with. Such information can be automatically retrieved from the device 12 without further action by the owner. If the owner chooses not to accept registration for the lock service, then the process jumps to step 58.

In step 58, the device 12 presents the owner with an option to pre-register in a lost and found database. If, in step 60, the offer is accepted, the details of the device 12 are pre-registered with the lost and found database 28, in step 62. At this point, conditional permission to publish details of the device 12 has effectively been received by the system 10, the condition being satisfied when the system is later informed that the device is lost or stolen. If the owner chooses not to accept registration for the lock service in step 60, then the process skips step 62. After step 62, and after all other steps relating to the OOBE have been completed, then the OOBE process ends at step 64.

Note that this flowchart has been presented as an exemplary embodiment and for clarity of explanation. It may be implemented differently, such as in a different sequence, providing that the functions described by it are achieved. For example, if there is no internet or other network connection available during the OOBE, then the device 12 may automatically complete the registration 56 and pre-registration 62 after the OOBE has ended, without further input from the owner.

FIG. 4 is a flowchart of a process carried out by the system 10 following theft or loss of a device 12. In step 70, the system 10 receives a request to lock the device 12, which may be received by the owner via terminal 30 for example. Following this, in step 72, the server 20 establishes a communication link with the device 12, which may be initiated by either the device or the server. In step 74, the server 20 sends a lock command to the device 12. The lock command results in a reduction of functionality available on the device 12. For example, it may limit the device, if it is a phone, to calling a specified number in order to inform a responsible party of the whereabouts of the device. Alternately, it may simply display a number to call or an email address to contact.

In step 76, the system 10 automatically publishes the device and its identifying details, such as a serial number, in the lost and found database 28. The details may already be stored there and a flag may simply be set to indicate that the device is now lost or stolen, which results in the details of the lost or stolen device 12 becoming publically available. The benefit is that, once the owner has logged on to the server 20, a single command can be used to both request that the device 12 be locked and publish the device in a lost and found database. Such a command may be labeled “Launch security and return measures.”

Optionally, if the owner has not given permission for the device 12 to be pre-registered with the lost and found database 28 during the OOBE, then, prior to step 76, the system may again present the owner with step 58 of FIG. 3, in which the owner is presented with the offer of listing the device as lost or stolen in the lost and found database 28. If the owner accepts the offer, then step 76 is carried out, otherwise the process ends.

FIG. 5 is a flowchart of a process carried out by the system 10 after a lost or stolen device 12 is found. In step 80, the system 10 receives a notification that a device 12 published as lost or stolen has been found. Such a notification may be received via terminal 32, for example. The finder of the device 12 will have verified, for example, that the serial number of the device matches the serial number displayed on a website that presents information about devices marked in the database 28 as lost or stolen.

Upon receipt of such notification, the server 20 informs the owner or an appointed responsible party that the device 12 has been found, in step 82. The system 10 can arrange for the finder and the owner to communicate with each other in order to establish how the device can be returned to the owner. Likewise, the communication can alternately be arranged between the finder and the responsible party. The server 20 may then offer the owner a discount on the purchase of a further or a more extensive device protection plan, in step 84. Such a device protection plan may be offered by the responsible party.

Many consumers like to try a product or service for free before committing to pay for it, or they like to pay for services they actually use. The disclosed system 10 is a tool that aligns well with this behaviour. Instead of users paying up front for a protection plan that they may never need to invoke, they can be given the option of registering for a free device lock service and/or lost and found database service. At the moment either or both services need to be used, the owner can be prompted to pay for such service. Having pre-registered, which is an essential step for the device lock to work, and the fact that such registration is free mean that the moment of requesting device lock and/or publishing it as lost or stolen becomes a fair and reasonable point in time for the owner to pay. The amount of payment can be anything but it may, for example, be more than what the owner would have paid up front for the same or a more complete device protection service. Alternately, the device lock and publishing it as lost or stolen may be free, and the owner may be charged a fee for the return of the device when it is actually found. Such a fee may optionally include an amount to cover a reward for the finder of the device. Allowing the owner to instruct the system 10 to lock the device 12 without having to submit credit card information on what is possibly another person's device would make the process more efficient and acceptable for the owner, and place less demand on a potentially borrowed device.

An additional benefit of this system is that it tends to focus the recording of lost or stolen devices in a single, worldwide database. With prior art offerings, owners of a particular make of device can choose any lost and found database in which to register a stolen device, and as a result there are several of them in existence. In contrast, if the OOBEs of a particular make of device are all configured to direct the owners to a common database, then this database will obviously be the one for finders to look at for that make of device, improving the chances that the finders will actually take the trouble to consult it. The effect is magnified if multiple manufacturers configure their device OOBEs to point to the same lost and found database. Having a single database to search is significantly more efficient for finders of lost devices than a series of multiple, smaller databases.

Note that functions described as being performed by one server may be divided between separate servers, and functions described as being performed on multiple servers may be combined on the same server. Intermediate servers may also be employed in the system. Terminals shown as a single terminal may instead be multiple terminals, for example multiple terminals in a police department.

Steps in the flowcharts may be performed in a different order to that illustrated, or they may be combined where shown separately. Steps may be omitted and others added, and steps from different flowcharts may be interchanged, all without departing from the scope of the invention. In an embodiment, one or more parts of the process may be performed manually.

As well as locking the device 12, the system may also be configured to provide other loss or theft protection services, such as capturing information such as IP address, device location (e.g. by GPS, Wi-Fi triangulation), name of carrier and IMEI. Data deletion, data retrieval or data encryption may be performed. Keystroke logging, image capture and video capture may also be provided.

Databases 26, 28 may be combined into one or split into several. They may be part of or separate from the server 20, they may be duplicated, cached and geographically distributed. Databases 26 and 28 may be operated by different service providers.

As well as, or instead of, the serial number of the device 12 being used for its identification, serial numbers of one or more of its components may be used or an electronically generated serial number may be used.

The device may be a tracking device affixed to another item to be protected. In this case, the tracking device may control some functionality of the device to which it is affixed, so that when a lock command is received, it limits some or all of the functions of the device. As well as having its own serial number, it may also have the ability to store the serial number or other identification of the device to which it is connected.

If the telephone number of a device 12 is changed, an application in the device may be automatically configured to report the new telephone number to the server 20.

Instead of pre-registering for a lost and found database, the option may be provided to the owner only at the time of submitted a lock device command, instead of during the OOBE. In this case, all the necessary information would still be collected at the time the owner registers for the lock service, but would only be forwarded from the lock service to the lost and found database service after the theft or loss of the device and after a lock command has been requested.

A lost or stolen device may be registered with multiple lost and found databases. This may occur automatically, or the user may be given an option to choose which ones to register with. The choice may be made during the OOBE or after the theft, when the owner submits a lock device request.

The system 10 may be informed by a finder of a lost or stolen device phoning a responsible party, who may then enter the information into the database 28 to indicate that the device has been found. A phone number for such purpose may be printed on or affixed to the device 12, so that it is visible when the device's battery is discharged.

Prior to the theft being reported, the device 12 itself may detect that it has been stolen and transmits a notification of such theft to the server 20. For example, the device may detect that a predetermined number of incorrect password attempts have been made in order to try to unlock the device, where a password may be alphanumeric, a voice input, a biometric input, an on-screen gesture or an air gesture, for example. As soon as a series of such incorrect password entry attempts is detected then the device may invoke one or more of the security actions mentioned above.

Motion detectors in the device may determine that the device has been stolen. For example, the owner of the device may be walking down the street checking his text messages and listening to music. An opportunistic thief may snatch the device and run away into the crowd or into an alley before the owner has chance to react. Upon the motion detector (e.g. tri-axial accelerometer) detecting such an abrupt change in motion, the device can automatically lock and undertake other security measures. The device may record the pattern of motion; take photos, videos and record sound; record the time of the change; respond to a shout of “help” from the owner using voice recognition software, and automatically dial the police as a consequence. Recording may be stealthy so as not to alert a thief.

In a similar way, the behavioural use of the device may be monitored in order to detect any unusual change in the behavioural pattern, which may be used to detect a theft.

The device may continually make a rolling recording of its environment (motions, sounds, location, weather, temperature, snapshots, screenshots, videos, audio, etc), saving information going back a predetermined amount of time only, such as an hour. In the event of a detection of theft, the environment information stored in the memory is not erased, but sent to the server, together with an ongoing recording of the environment post-theft. Again, recording may be stealthy so as not to alert a thief.

If the device 12 autodetects that it has been stolen or lost, then it may automatically be published as lost or stolen in the lost and found database 28. If the device 12 autodetects that it may be lost or stolen, then any protection measures taken will be precautionary, and may be reversed or canceled upon entry of a correct password by the owner, at which point it will be delisted from the lost and found database. Reversal of a kill switch may be undertaken if, for example, the kill switch entails the transfer of data stored on the device to a server before, during or after making the device otherwise inoperative as a result of its receiving a lock command.

The present description is of the best presently contemplated mode of carrying out the subject matter disclosed and claimed herein. The description is made for the purpose of illustrating the general principles of the subject matter and not be taken in a limiting sense; the subject matter can find utility in a variety of implementations without departing from the scope of the disclosure made, as will be apparent to those of skill in the art from an understanding of the principles that underlie the subject matter.

1. A method for protecting electronic devices, comprising:
receiving by an electronic device, during an out of box experience of the device, user contact data for a purpose other than for registering for a remote lock service;
presenting, by the device during the out of box experience, an opportunity to register the device with the remote lock service;
receiving, by the device during the out of box experience, an acceptance of said opportunity;
the device using said user contact data to register the device with a server which provides the remote lock service;
receiving, by said lock service, a notification of loss or theft of the device; and
transmitting a lock command from the server to the device.

2. The method of claim 1, further comprising:
the device receiving the lock command; and
the device restricting its functionality after receiving the lock command.

3. The method of claim 1, further comprising:
presenting, by the device during the out of box experience, an opportunity to pre-register the device with a lost and found service;
receiving, by the device during the out of box experience, an acceptance of said opportunity to pre-register the device with the lost and found service; and
the device using said user contact data to register the device with the lost and found service.

4. The method of claim 3, further comprising:
publishing, on a server, that the device is lost or stolen.

5. The method of claim 3, wherein the receiving of the acceptance of the opportunity to register the device with the remote lock service and the receiving of the acceptance of the opportunity to pre-register the device with the lost and found service occur simultaneously.

6. The method of claim 1, further comprising,
after receiving said notification:
presenting, by the server, an opportunity to register the device with a lost and found service;
receiving, by the server, an acceptance of said opportunity to register the device with the lost and found service;
the server using said user contact data to register the device with the lost and found service; and
publishing, by the lost and found service, that the device is lost or stolen.

7. The method of claim 1, further comprising:
the device automatically sending an identification of the device to the server when registering the device for the remote lock service.

8. The method of claim 1, wherein the device transmits said notification to the server.

9. The method of claim 2, wherein the device stealthily records one or more aspects of its environment after receiving the lock command.

10. One or more non-transitory computer readable media comprising computer readable instructions, which, when processed by one or more processors, cause:
an electronic device to receive, during an out of box experience of the device, user contact data for a purpose other than for registering for a remote lock service;
the device to present, during the out of box experience, an opportunity to register the device with the remote lock service;
the device to receive, during the out of box experience, an acceptance of said opportunity;
the device to use said user contact data to register the device with a server which provides the remote lock service;
the lock service to receive a notification of loss or theft of the device; and
the lock service to transmit a lock command from the server to the device.

11. The media of claim 10, further causing:
the device to receive the lock command; and
the device to restrict its functionality after receiving the lock command.

12. The media of claim 10, further causing:
the device to present, during the out of box experience, an opportunity to pre-register the device with a lost and found service;
the device to receive, during the out of box experience, an acceptance of said opportunity to pre-register the device with the lost and found service; and
the device to use said user contact data to register the device with the lost and found service.

13. The media of claim 12, further causing said service to publish that the device is lost or stolen.

14. The media of claim 12, wherein the acceptance of the opportunity to register the device with the remote lock service and the acceptance of the opportunity to pre-register the device with the lost and found service occur simultaneously.

15. The media of claim 10, further causing,
after said notification has been received:
the server to present an opportunity to register the device with a lost and found service;
the server to receive an acceptance of said opportunity to register the device with the lost and found service;
the server to use said user contact data to register the device with the lost and found service; and
the lost and found service to publish that the device is lost or stolen.

16. The media of claim 10, further causing the device to automatically send an identification of the device to the server when the device registers for the remote lock service.

17. A system for protecting electronic devices comprising:
an electronic device configured to:
receive, during an out of box experience of the device, user contact data for a purpose other than for registering for a remote lock service;
present, during the out of box experience, an opportunity to register the device with the remote lock service;
receive, during the out of box experience, an acceptance of said opportunity; and
use said user contact data to register the device with a server which provides the remote lock service; and
the server, configured to:
provide the remote lock service;
receive a notification of loss or theft of the device; and
transmit a lock command to the device.

18. The system of claim 17, further comprising:
a lost and found service, comprising a database of electronic devices that may be published as lost or stolen,
wherein the electronic device is further configured to:
present, during the out of box experience, an opportunity to pre-register the device with the lost and found service;
receive, during the out of box experience, an acceptance of said opportunity to pre-register the device with the lost and found service; and
use said user contact data to register the device with the lost and found service.

19. The system of claim 17, wherein the device is further configured to:
receive the lock command; and
restrict the functionality of the device upon receipt of the lock command.

20. The system of claim 17, wherein the server is further configured to:
present, after said notification has been received, an opportunity to register the device with a lost and found service;
receive an acceptance of said opportunity to register the device with the lost and found service; and
use said user contact data to register the device with the lost and found service; and
the lost and found service is further configured to publish that the device is lost or stolen.
